(19) United States
(12) Patent Application Publication
(10) Pub. No.: US 2025/0156777 A1
(43) Pub. Date: May 15, 2025

(54) DATA TASK MANAGEMENT METHOD AND APPARATUS, READABLE MEDIUM, AND ELECTRONIC DEVICE

(71) Applicant: Beijing Volcano Engine Technology Co., Ltd., Beijing (CN)

(72) Inventors: Yuhan ZHANG, Beijing (CN); Shuisheng ZHANG, Beijing (CN); Danchi FAN, Beijing (CN)

(21) Appl. No.: 18/941,151

(22) Filed: Nov. 8, 2024

(30) Foreign Application Priority Data
Nov. 9, 2023 (CN) 202311491506.2

(51) Int. Cl. G06Q 10/0631

(52) U.S. Cl. CPC G06Q 10/06311

(57) ABSTRACT

The present disclosure relates to a data task management method and apparatus, a readable medium, and an electronic device. The method includes: determining, in response to a selection operation for a task link corresponding to a target data task, at least one sub-data task included in a target task link corresponding to the selection operation; and displaying task time information of the at least one sub-data task included in the target task link in a form of a Gantt chart, according to a hierarchical relationship of the at least one sub-data task, wherein different timing relationships between task completion time of the at least one sub-data task and service level agreement time of the at least one sub-data task are displayed in the Gantt chart through different display styles.

### CROSS-REFERENCE TO RELATED APPLICATION

This application claims priority to Chinese Patent Application No. 202311491506.2, filed on Nov. 9, 2023, which is incorporated herein by reference in its entirety as a part of this application.

### TECHNICAL FIELD

The present disclosure relates to a data task management method and apparatus, a readable medium, and an electronic device.

### BACKGROUND

A data service refers to related activities and services involving data. Through the data service, business data required may be collected and managed, thereby using the business data to support a corresponding business to operate.

The data service in the related art depends on the collaboration of a plurality of business teams. If a downstream business team needs to generate business data at a certain moment, it is necessary to coordinate a plurality of upstream business teams for collaboration, so as to ensure that the downstream business team can complete a corresponding data task on time.

### SUMMARY

The Summary is to introduce the concepts in a simplified form, which will be described in detail in the following Detailed Description. The Summary is not intended to identify key features or essential features of the claimed technical solutions, nor is it intended to be used to limit the scope of the claimed technical solutions.

In a first aspect, the present disclosure provides a data task management method. The method includes:
determining, in response to a selection operation for a task link corresponding to a target data task, at least one sub-data task included in a target task link corresponding to the selection operation; and
displaying task time information of the at least one sub-data task included in the target task link in a form of a Gantt chart, according to a hierarchical relationship of the at least one sub-data task, wherein different timing relationships between task completion time of the at least one sub-data task and service level agreement time of the at least one sub-data task are displayed in the Gantt chart through different display styles.

In a second aspect, the present disclosure provides a data task management apparatus. The apparatus includes:
a first determination module, configured to determine, in response to a selection operation for a task link corresponding to a target data task, at least one sub-data task included in a target task link corresponding to the selection operation; and
a first display module, configured to display task time information of the at least one sub-data task included in the target task link in a form of a Gantt chart, according to a hierarchical relationship of the at least one sub-data task, wherein different timing relationships between task completion time of the at least one sub-data task and service level agreement time of the at least one sub-data task are displayed in the Gantt chart through different display styles.

In a third aspect, the present disclosure provides a computer-readable medium having a computer program stored thereon, wherein when the program is executed by a processing apparatus, the steps of the method according to any one of the first aspect are implemented.

In a fourth aspect, the present disclosure provides an electronic device, including:
a storage apparatus having a computer program stored thereon; and
a processing apparatus configured to execute the computer program in the storage apparatus to implement the steps of the method according to any one of the first aspect.

Other features and advantages of the present disclosure will be described in detail in the following Detailed Description.

### BRIEF DESCRIPTION OF DRAWINGS

The above and other features, advantages and aspects of the embodiments of the present disclosure will become more apparent with reference to the following specific embodiments and in conjunction with the accompanying drawings. Throughout the drawings, the same or similar reference numerals denote the same or similar elements. It should be understood that the accompanying drawings are schematic and that parts and elements are not necessarily drawn to scale. In the drawings:

FIG. 1 is an execution flowchart of a data task according to an exemplary embodiment of the present disclosure;

FIG. 2 is a flowchart of a data task management method according to an exemplary embodiment of the present disclosure;

FIG. 3 is a schematic diagram of a task link of a target data task according to an exemplary embodiment of the present disclosure;

FIG. 4 is a schematic diagram of displaying task time information of a sub-data task in a target task link in the form of a Gantt chart according to an exemplary embodiment of the present disclosure;

FIG. 5 is a schematic diagram of displaying task time information of a sub-data task in a target task link in the form of a Gantt chart according to another exemplary embodiment of the present disclosure;

FIG. 6 is a schematic diagram of displaying task time information of a sub-data task in a target task link in the form of a Gantt chart according to another exemplary embodiment of the present disclosure;

FIG. 7 is a schematic diagram of displaying task time information and task attribute information according to an exemplary embodiment of the present disclosure;

FIG. 8 is a schematic diagram of selecting a target task link according to an exemplary embodiment of the present disclosure;

FIG. 9 is a schematic diagram of switching from a Gantt chart interface to a list mode management interface according to an exemplary embodiment of the present disclosure;

FIG. 10 is a schematic diagram of switching from a Gantt chart interface to a directed acyclic graph mode management interface according to an exemplary embodiment of the present disclosure;

FIG. 11 is a schematic diagram of a task screening operation according to an exemplary embodiment of the present disclosure;

FIG. 12 is a block diagram of a structure of a data task management apparatus according to an exemplary embodiment of the present disclosure;

FIG. 13 is a schematic diagram of a structure of an electronic device according to an exemplary embodiment of the present disclosure; and

FIG. 14 is a schematic diagram of a structure of a non-transitory computer-readable medium according to an exemplary embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The term “include/comprise” used herein and the variations thereof are an open-ended inclusion, that is, “include/comprise but not limited to”. The term “based on” is “at least partially based on”. The term “an embodiment” means “at least one embodiment”; the term “another embodiment” means “at least one another embodiment”; the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or the interdependence relationship.

It should be noted that the modifiers “one” and “a plurality of” mentioned in the present disclosure are illustrative and not restrictive, and those skilled in the art should understand that unless the context clearly indicates otherwise, it should be understood as “one or more”.

Names of messages or information exchanged between a plurality of apparatuses in the implementations of the present disclosure are only for illustrative purposes and are not used to limit the scope of these messages or information.

It may be understood that before using the technical solution disclosed in each embodiment of the present disclosure, the type, scope of use, use scenario and the like of personal information involved in the present disclosure should be informed to the user and the user's authorization should be obtained through an appropriate manner in accordance with relevant laws and regulations.

For example, when receiving an active request from a user, a prompt message is sent to the user to clearly prompt the user that an operation requested by the user will need to obtain and use the user's personal information. In this way, the user can independently choose whether to provide personal information to the software or hardware such as an electronic device, an application, a server, or a storage medium that performs the operation of the technical solution of the present disclosure according to the prompt message.

As an optional but non-limiting implementation manner, the manner of sending a prompt message to the user in response to receiving the active request from the user may be, for example, a pop-up window, and the prompt message may be presented in text in the pop-up window. In addition, the pop-up window may also carry a selection control for the user to select “agree” or “disagree” to provide personal information to the electronic device.

It may be understood that the above process of notifying and obtaining the user's authorization is only schematic and does not limit the implementation of the present disclosure. Other manners that meet relevant laws and regulations may also be applied to the implementation of the present disclosure.

It can be understood that the data involved in the technical solution of the present disclosure (including but not limited to the data itself, the acquisition or use of the data) shall comply with the requirements of corresponding laws, regulations, and related provisions.

As mentioned in the Background Art, the data service depends on the collaboration of a plurality of business teams. If a downstream business team needs to generate target business data at a certain moment, it is necessary to coordinate a plurality of upstream business teams for collaboration, so as to ensure that the downstream business team can complete a corresponding target data task on time.

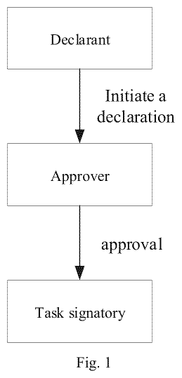

In the related art, in order to ensure that the target data task can be completed on time, after the downstream business team initiates a requisition for the data task, the corresponding upstream business team will sign the service level agreement (SLA) time of the sub-data task according to the details of the data task in the requisition, that is, sign the promised time to complete the sub-data task, so as to ensure that the data task can be completed on time. Specifically, as shown in FIG. 1 and Table 1.

TABLE 1
flowchart for executing the data task

| | | | |
|---|---|---|---|
| User role | Declarant/demander | Approver | Task signatory |
| Role description | Downstream business | Data governance | Upstream business data |
| | data team | committee | team |
| User objective | Submit a data taskto | ensure the rationality | Sign the task to ensure |
| | requisition | Complete the approval | that the corresponding |
| | | of the data task | sub-data task is |
| | | requirement | completed within the |
| | | | SLA time |
| Core task | Initiate a data task | Approval | Sign |
| Focus | Approval of the data | Details and requirement | Sign the task and |
| | task requisition, signing | rationality of the data | execution status |
| | process, and whether the | task requisition | |
| | task execution meets the | | |
| | expectation | | |

In addition, in order to be able to timely understand the execution status of the data task, the related art also displays the task information of each sub-data task in a form of a table, such as the execution time, the average completion time, and the SLA time of the sub-data task. Since the data task generally includes a plurality of sub-data tasks, and there are different task hierarchy relationships between different sub-data tasks, it is impossible to quickly perceive the completion status of each sub-data task, the time difference of the sub-data tasks between adjacent task hierarchies, and the delay task (that is, a task whose actual completion time is later than the service level agreement time) cannot be quickly located through the form of the table.

In view of this, the embodiments of the present disclosure provide a data task management method and apparatus, a readable medium, and an electronic device to solve the above technical problems.

The following further explains the embodiments of the present disclosure in conjunction with the accompanying drawings.

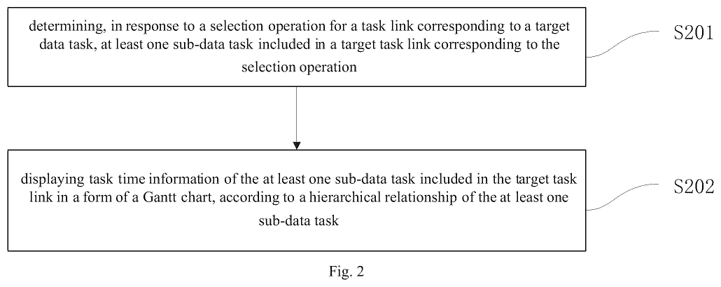

FIG. 2 is a flowchart of a data task management method according to an exemplary embodiment of the present disclosure. Referring to FIG. 2, the method may include the following steps:

S201: determining, in response to a selection operation for a task link corresponding to a target data task, at least one sub-data task included in a target task link corresponding to the selection operation.

It should be understood that the target data task may generally include a plurality of sub-data tasks, and there are different task hierarchy relationships (execution dependency relationships) between different sub-data tasks. Therefore, the target data task may be disassembled into at least one task link according to the hierarchical relationships between the sub-data tasks. Therefore, the sub-data task(s) included in the target task link may be obtained through the selection operation for the task link.

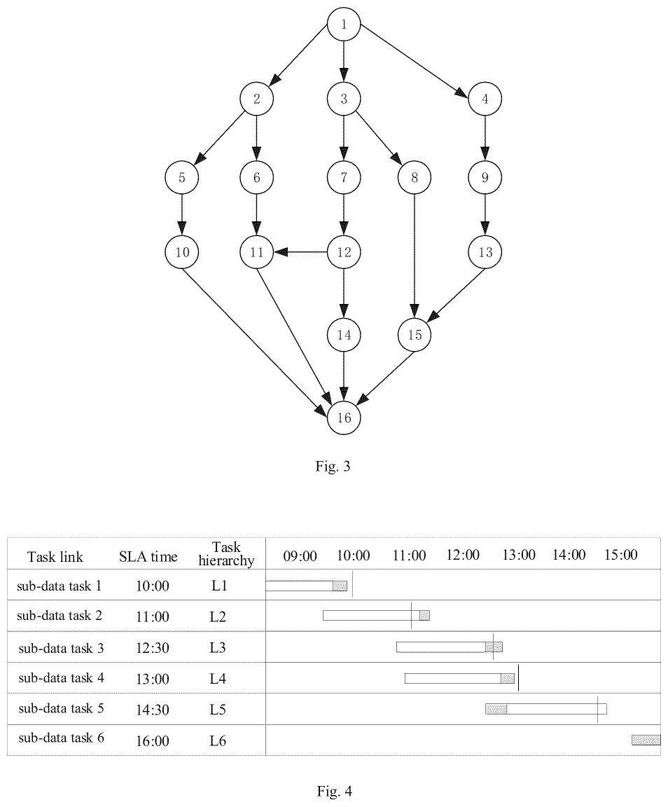

For example, as shown in FIG. 3, FIG. 3 is a target data task. It can be seen from the arrow pointing in the figure that the target data task may be disassembled into five task links (a first task link: 1-2-5-10-16, a second task link: 1-2-6-11-16, a third task link: 1-3-7-12-11 (14)-16, a fourth task link: 1-3-8-15-16, and a fifth task link: 1-4-9-13-15-16). Therefore, the corresponding sub-data task may be obtained through the selection operation for the task link. For example, by selecting the second task link, the sub-data task 1, the sub-data task 2, the sub-data task 6, the sub-data task 11, and the sub-data task 16 may be obtained.

S202: displaying task time information of the at least one sub-data task included in the target task link in a form of a Gantt chart, according to a hierarchical relationship of the at least one sub-data task, wherein different timing relationships between task completion time of the at least one sub-data task and service level agreement time of the at least one sub-data task are displayed in the Gantt chart through different display styles.

Through the above technical solution, the task link of the target data task may be selected, and the task time information of each sub-data task may be displayed in the form of a Gantt chart according to the task hierarchy of each sub-data task in the selected target task link. In this way, the task time information of each sub-data task may be displayed intuitively. In another aspect, because the task time information in the form of the Gantt chart is displayed according to the task hierarchy, a time difference of the sub-data tasks between adjacent hierarchies may be quickly determined, so that the time information of the sub-data tasks is adjusted in a coordinated manner to ensure that the target data task can be completed on time. In addition, because different timing relationships between the task completion time and the service level agreement time of the sub-data task may be displayed in the Gantt chart through different display styles, the execution status of each sub-data task may be quickly determined according to the timing relationship between the task completion time and the service level agreement time, and an abnormal problem in the execution process of the sub-data task can be found in time.

In a possible implementation, the displaying task time information of the at least one sub-data task included in the target task link in a form of a Gantt chart may include:
displaying, for each sub-data task included in the target task link, an average execution time period of the sub-data task in a first rectangular box, an actual execution time period of the sub-data task in a second rectangular box, and service level agreement time of the sub-data task in a graphic marker, wherein the first rectangular box and the second rectangular box are displayed in different display styles.

It should be understood that the display styles of the first rectangular box and the second rectangular box may be set according to actual conditions, and the embodiments of the present disclosure are not limited thereto. In a possible implementation, the difference between the display style of the first rectangular box and the display style of the second rectangular box may be that the background color of the rectangular box is different, the background image of the rectangular box is different, or the size of the rectangular box is different.

In addition, it should be understood that the graphic marker used to display the service level agreement time may also be set according to actual conditions, and the embodiments of the present disclosure are not limited thereto. In a possible implementation, the service level agreement time may be marked and displayed by a triangle, a five-pointed star or a circle.

For example, as shown in FIG. 4, the average execution time period of the sub-data task may be represented by a rectangular box with a gray background, the actual execution time period of the sub-data task may be represented by a rectangular box with a white background, and the service level agreement time of the sub-data task may be represented by a vertical line segment.

Through the above technical solution, the actual execution time period, the service level agreement time, and the average completion time of each sub-data task included in the target task link may be visually displayed in a visual (graphical) manner. This helps the user to more reasonably arrange the service level agreement time and the actual execution time period to ensure that the target data task can be completed on time. For example, if the average execution time period of a certain sub-data task in 14 days is from 6:00 to 7:00, the SLA time may be set at about 7:00 to ensure that the sub-data task can be completed on time.

In a possible implementation, the displaying task time information of the at least one sub-data task included in the target task link in a form of a Gantt chart, may include:
for each sub-data task included in the target task link, when the task completion time of the sub-data task in the target task link is earlier than the service level agreement time of the sub-data task, displaying a timing relationship between the task completion time of the sub-data task and the service level agreement time of the sub-data task in a rectangular box with a first style; when the task completion time of the sub-data task in the target task link is later than the service level agreement time of the sub-data task, displaying a timing relationship between the task completion time of the sub-data task and the service level agreement time of the sub-data task in a rectangular box with a second style, wherein the first style is different from the second style.

It should be understood that the first style and the second style may be set according to actual conditions, and the embodiments of the present disclosure are not limited thereto. In a possible implementation, the difference between the rectangular box in the first style and the rectangular box in the second style may be that the background color of the rectangular box is different or the background image of the rectangular box is different.

In a possible implementation, the displaying a timing relationship between the task completion time of the sub-data task and the service level agreement time of the sub-data task in a rectangular box with a first style, may include:
displaying, in a first display color, a rectangular box representing an actual execution time period of the sub-data task, and/or displaying the rectangular box representing the actual execution time period of the sub-data task and a graphic marker representing the service level agreement time of the sub-data task in a non-overlapping manner; and
the displaying a timing relationship between the task completion time of the sub-data task and the service level agreement time of the sub-data task in a rectangular box with a second style, may include:
displaying, in a second display color, a rectangular box representing the actual execution time period of the sub-data task, and/or displaying the rectangular box representing the actual execution time period of the sub-data task and the graphic marker representing the service level agreement time of the sub-data task in an overlapping manner.

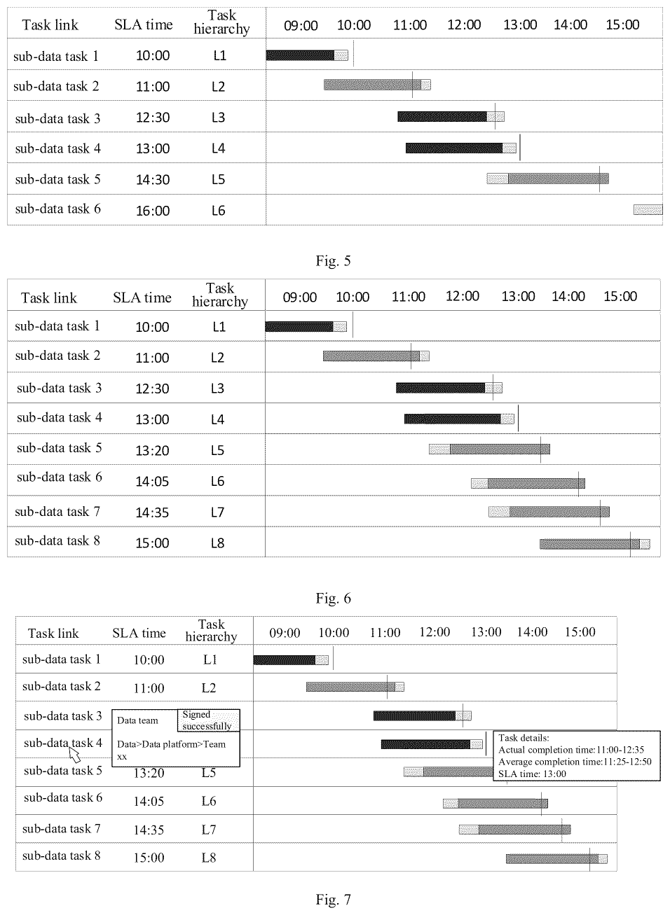

For example, as shown in FIG. 5, a rectangular box with a black background may be used to represent that the task completion time of the sub-data task is earlier than the service level agreement time of the sub-data task, a rectangular box with a dark gray background may be used to represent that the task completion time of the sub-data task is later than the service level agreement time of the sub-data task, and the rectangular box whose task completion time of the sub-data task is later than the service level agreement time of the sub-data task and the graphic marker are displayed in an overlapping manner.

Through the above technical solution, the timing relationship between the task completion time and the service level agreement time may be represented by the rectangular boxes in different styles, so that the completion status of each sub-data task, that is, whether the task is completed before the promised time (SLA time), may be quickly determined according to the display style of the rectangular box, and then an abnormal check, i.e., checking which sub-data task causes the target task not to be completed on time, maybe quickly performed.

For example, as shown in FIG. 6, a delayed task (that is, a task that is not completed before the SLA time) may be quickly located by finding the rectangular box with the dark gray background, and the sub-data task that has the greatest impact on the execution status of the target data task. It can be learned from FIG. 6 that the delayed tasks include the sub-data task 2, the sub-data task 5, the sub-data task 6, the sub-data task 7, and the sub-data task 8. Although the sub-data task 2 is not completed before the SLA time, the subsequent sub-data tasks 3 and 4 are normally executed. Therefore, the sub-data task 2 has little impact on the execution status of the target data task. However, all the sub-data tasks subsequent to the sub-data task 5 are delayed. Therefore, it may be determined that the final target data task is delayed because of the delay of the sub-data task 5.

In a possible implementation, the Gantt chart displays execution time information of the at least one sub-data task in the form of a rectangular box, and the method may further include:
in response to a hover operation or a selection operation for a target rectangular box in the Gantt chart, displaying task time information of a sub-data task corresponding to the target rectangular box, wherein the task time information comprises at least one selected from the group consisting of average completion time, actual completion time, and service level agreement time of the sub-data task; and/or
when task identification information of a sub-data task is displayed, displaying task attribute information of the sub-data task corresponding to the task identification information in response to a hover operation or a selection operation for the task identification information, wherein the task attribute information comprises a signature status of the service level agreement time of the sub-data task and/or business team information to which the sub-data task belongs.

The task identification information may be a task name of the task, or a task identifier of the task. This is not limited in the embodiments of the present disclosure.

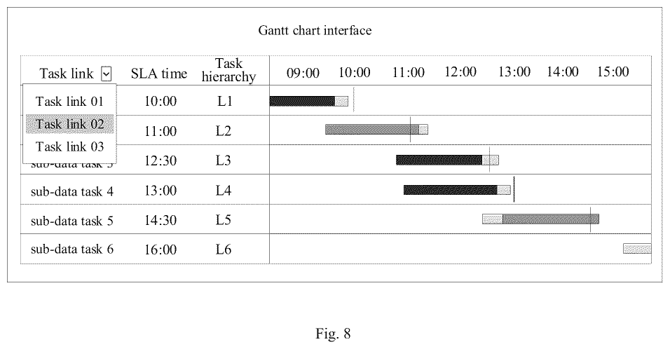

For example, as shown in FIG. 7, by clicking on a rectangular box corresponding to the sub-data task 4, a time information card is displayed around the rectangular box in a floating layer, and the average completion time, the actual completion time, and the service level agreement time corresponding to the sub-data task 4 are displayed in the time information card. By hovering a mouse over the task identification information, for example, by hovering the mouse over the task name “sub-data task 4”, an attribute information card is displayed around the “sub-data task 4” in a floating layer, and the signature status of the corresponding service level agreement time and the business team information to which the task belongs are displayed in the attribute information card.

In a possible implementation, in order to facilitate reminding the related person to sign the service level agreement time, when the signature status of the service level agreement time is an unsigned status, a reminder control may also be displayed in the time information card and/or the attribute information card, and a prompt message is sent to the corresponding signer by triggering the reminder control.

Through the above technical solution, the task time information corresponding to the task corresponding to the target rectangular box or the task attribute information corresponding to the task corresponding to the task identification information may be displayed when the target rectangular box or the task identification information is clicked, or the mouse hovers over the target rectangular box or the task identification information. In this way, the user can understand the timing relationship between the task completion time of each sub-data task and the corresponding service level agreement time, and can also understand the task time information/the task attribute information of each sub-data task intuitively and quickly, further improving the user experience.

In a possible implementation, the Gantt chart displays execution time information of the at least one sub-data task in a form of a rectangular box, and the Gantt chart displays the service level agreement time of the at least one sub-data task in a first graphic marker, and the method may further include:
displaying first graphic markers corresponding to sub-data tasks with different signature statuses in different colors, wherein the signature statuses are signature statuses of the service level agreement time of the sub-data tasks; and/or when task identification information of a sub-data task corresponding to the rectangular box is displayed, displaying a signature status around the task identification information through a second graphic marker, wherein different signature statuses are displayed in different styles of second graphic markers, and the first graphic marker is different from the second graphic marker.

It should be understood that the colors of the first graphic markers corresponding to the sub-data tasks with different signature statuses may be set according to actual conditions, and the embodiments of the present disclosure are not limited thereto. For example, an orange first graphic marker may be used to represent the to-be-signed status, a green first graphic marker may be used to represent the successfully signed status, a red first graphic marker may be used to represent the refuse-to-sign status, a blue first graphic marker may be used to represent the signed suspension status, and a gray first graphic marker may be used to represent the no-need-to-sign status. In this way, the signature status of the service level agreement time of each sub-data task may be intuitively and quickly determined through the display color of the first image marker, improving the user experience.

In addition, it should be understood that the second graphic used to mark and display the signature status and the display style of the second graphic marker corresponding to different signature statuses may also be set according to actual conditions, and the embodiments of the present disclosure are not limited thereto. In a possible implementation, a dot may be used to represent the second graphic marker, and different signature statuses are marked and displayed through different display colors. For example, an orange dot may be used to represent the to-be-signed status, a green dot may be used to represent the successfully signed status, a red dot may be used to represent the refuse-to-sign status, a blue dot may be used to represent the signed suspension status, and a gray dot may be used to represent the no-need-to-sign status. In this way, the signature status of the service level agreement time of each sub-data task may be intuitively and quickly determined through the display color of the dot, improving the user experience.

In a possible implementation, the method may further include:
determining, in response to a configuration operation for a display mode of the target data task, a display mode corresponding to the configuration operation, and displaying a Gantt chart interface when the display mode indicates to display the target data task in the form of a Gantt chart;

Accordingly, the determining, in response to a selection operation for a task link corresponding to a target data task, at least one sub-data task included in a target task link corresponding to the selection operation, may include:
determining, in response to the selection operation for the task link corresponding to the target data task in the Gantt chart interface, the at least one sub-data task included in the target task link corresponding to the selection operation.

It should be understood that the configuration operation for the display mode of the target data task may be to select a target display mode from a plurality of preset display modes, or to input the target display mode in a display mode input box. This is not limited in the embodiments of the present disclosure.

For example, a display mode input box is displayed on a configuration page used to configure the display mode of the target data task. By inputting a target display mode in the display mode input box, for example, inputting “Gantt chart display mode”, a Gantt chart interface is jumped to, as shown in FIG. 8. The Gantt chart interface displays a task link selection control “task link”. By clicking on the “task link”, a pull-down list is displayed, and the task links corresponding to the target data task are displayed in the pull-down list. By clicking on a target task link, for example, the task link 02, the sub-data tasks in the task link 02 are obtained, and the task time information of each sub-data task is displayed in the Gantt chart interface in the form of a Gantt chart according to the hierarchical relationship of the sub-data tasks in the task link 02.

In a possible implementation, the method may further include:
determining, in response to a switching operation for a display mode of the target data task, first display mode corresponding to the switching operation; and switching from the Gantt chart interface to first management interface corresponding to the first display mode, wherein the first display mode includes a list mode and/or a directed acyclic graph mode, the list mode is used to display task information of all sub-data tasks under the target data task in the form of a list, and the directed acyclic graph mode is at least used to display an execution dependency relationship between respective sub-data task in the target data task in a form of a directed acyclic graph.

It should be understood that the switching operation for the display mode of the target data task may be a trigger operation for a switching control, or a sliding operation for the Gantt chart interface. This is not limited in the embodiments of the present disclosure.

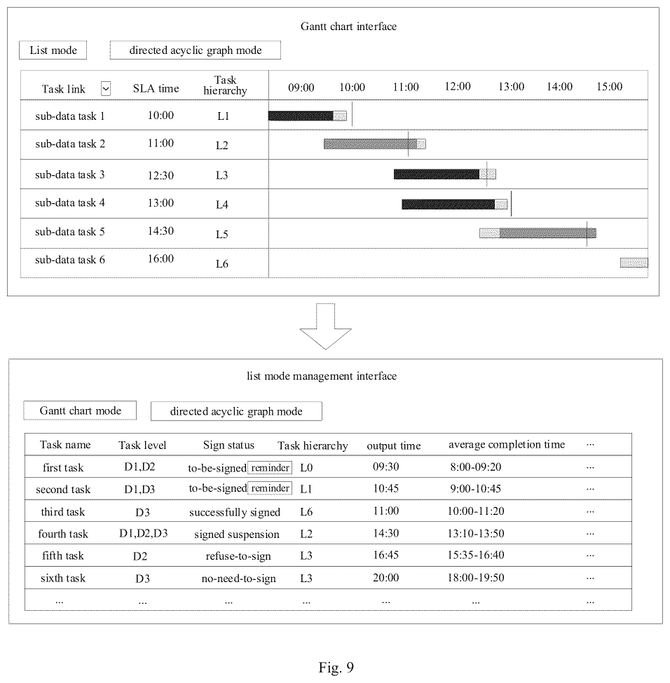

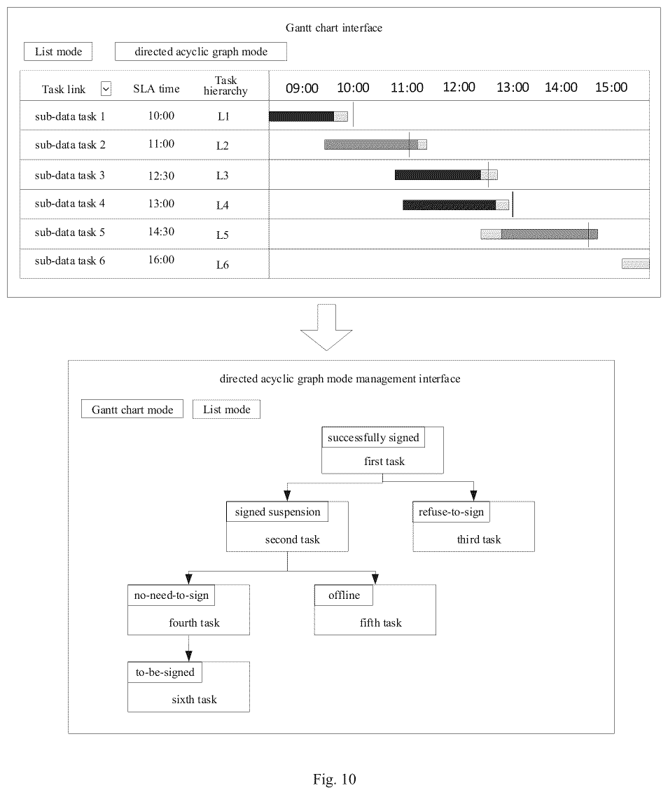

For example, the Gantt chart interface may display a first switching control “list mode” and a second switching control “directed acyclic graph mode”. By clicking on the “list mode”, the list mode management interface is switched to, as shown in FIG. 9. By clicking on the “directed acyclic graph mode”, the directed acyclic graph mode management interface is switched to, as shown in FIG. 10.

Similarly, when the current management interface is the list mode management interface or the directed acyclic graph mode management interface, the current management interface displays switching controls corresponding to the remaining display modes, so that by clicking on the switching controls corresponding to the remaining display modes, the current management interface jumps to the management interface corresponding to the remaining display modes. For example, if the current management interface is the list mode management interface, the current management interface displays a second switching control “directed acyclic graph mode” and a third switching control “Gantt chart mode”. By clicking on the “Gantt chart mode”, the Gantt chart interface is switched to. By clicking on the “directed acyclic graph mode”, the directed acyclic graph mode management interface is switched to.

In a possible implementation, in order to facilitate the user to quickly view the execution status of each sub-data task at the current time, when the Gantt chart interface is displayed or switched from the first management interface to the Gantt chart interface, the current time point may be automatically located in the Gantt chart interface. For example, if the user switches to the Gantt chart interface at 9:00, the first column in the Gantt chart interface is displayed as 9:00. The user may drag the Gantt chart interface left and right through a mouse and a touchpad to display the sub-data tasks corresponding to other time nodes.

Through the above technical solution, the display mode of the target data task may be switched, so that the task information of all sub-data tasks included in the target data task and/or the execution dependency relationship between the sub-data tasks under the target data task may be understood in an all-round way, and the execution status of the target data task may be mastered more comprehensively.

In a possible implementation, the method may further include:
determining, in response to a task screening operation, a screening condition corresponding to the task screening operation, and updating the task time information displayed in the Gantt chart according to the screening condition, so as to make the Gantt chart display task time information of a sub-data task that meets the screening condition.

It should be understood that the task screening operation may be to select a target screening condition from a plurality of preset screening conditions, or to input the target screening condition in a screening condition input box. This is not limited in the embodiments of the present disclosure.

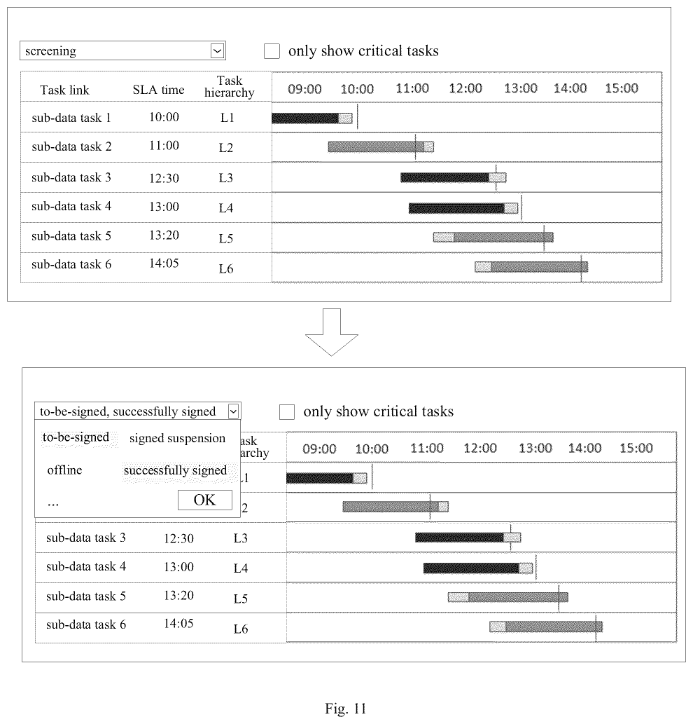

For example, as shown in FIG. 11, a management interface (the list mode management interface, the directed acyclic graph mode management interface, or the Gantt chart interface) displays a screening condition selection box, and a pull-down control is displayed in the screening condition selection box. By clicking on the pull-down control, a screening condition configuration page is displayed, and the screening condition configuration page displays a plurality of preset screening conditions. Through clicking on a desired screening condition, for example, clicking on “to-be-signed” and “successfully signed”, the target screening condition is obtained, so that the task time information displayed in the Gantt chart may be updated according to the target screening condition.

In a possible implementation, in order to more conveniently update the task time information displayed in the Gantt chart, the screening condition with high screening frequency may also be displayed on the management interface. In this way, the screening condition with high screening frequency may be directly checked on the management interface, thereby simplifying the complexity of the task screening operation and further improving the user experience. For example, as shown in FIG. 11, a screening condition “only show critical tasks” is displayed on the management interface. By checking the “only show critical tasks”, the task time information displayed in the Gantt chart is updated. The critical task refers to a task for which the output time needs to be promised to another task.

Through the above technical solution, the task time information displayed in the Gantt chart may be updated according to the configured screening condition, so that the Gantt chart only displays the task time information of the sub-data tasks that meet the screening condition. In this way, the required task time information may be quickly viewed, improving the user experience.

In a possible implementation, in order to conveniently and quickly change the status of the target data task, an operation control may also be displayed on the management interface. By triggering the operation control, a pull-down menu is displayed, and a plurality of preset operation items are displayed in the pull-down menu. The status of the target data task is changed by clicking on a target operation item. For example, the preset operation items may include confirming the completion of signing, pausing the signing, revoking the target data task, and taking the target data task offline, and the like. By clicking on taking the target data task offline, the target data task is taken offline, that is, all task links or all sub-data tasks of the target data task are taken offline.

It should be noted that the operation item of the target data task may be determined according to the status of the target data task, and the embodiments of the present disclosure are not limited thereto. For example, the operation items that may be performed by the target data tasks with different statuses may be shown in Table 2.

TABLE 2
Operation items that may be performed by the
target data tasks with different statuses

| Status | Operation item |
|---|---|
| Signing | Confirm the completion of signing, pause signing, |
| | revoke, and transfer (by the declarant) |
| Pausing guarantee | Resume guarantee, take offline, and transfer |
| | (by the declarant) |
| Pausing signing | Resume guarantee, take offline, and transfer |
| | (by the declarant) |
| Guaranteeing - signing | Pause guarantee, take offline, and transfer |
| completed | (by the declarant) |
| Guaranteeing - link | Pause guarantee, take offline, and transfer |
| change | (by the declarant) |
| To be approved | Revoke, transfer (by the declarant), reject, |
| | and approve |
| Rejected | — |
| Revoked | — |
| offline | — |

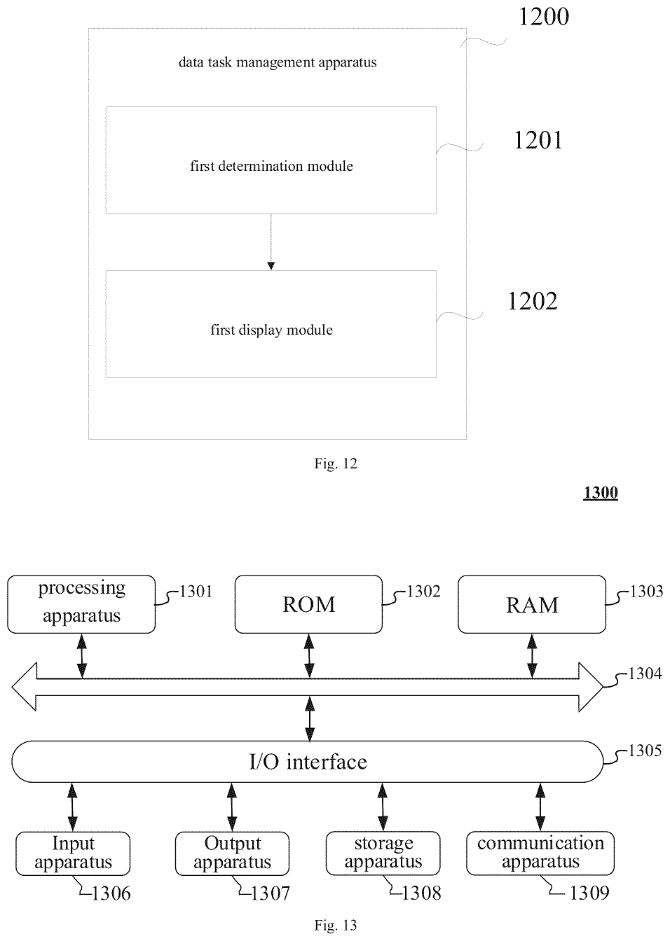

Based on the same concept, the embodiments of the present disclosure further provide a data task management apparatus. As shown in FIG. 12, the apparatus 1200 may include:
a first determination module 1201 configured to determine, in response to a selection operation for a task link corresponding to a target data task, at least one sub-data task included in a target task link corresponding to the selection operation; and
a first display module 1202 configured to display task time information of the at least one sub-data task included in the target task link in a form of a Gantt chart, according to a hierarchical relationship of the at least one sub-data task, wherein different timing relationships between task completion time of the at least one sub-data task and service level agreement time of the at least one sub-data task are displayed in the Gantt chart through different display styles.

Through the above data task management apparatus, the task link of the target data task may be selected, and the task time information of each sub-data task may be displayed in the form of a Gantt chart according to the task hierarchy of each sub-data task in the selected task link. In this way, the task time information of each sub-data task may be displayed intuitively. In another aspect, since the task time information in the form of the Gantt chart is displayed according to the task hierarchy, a time difference of the sub-data tasks between adjacent hierarchies may be quickly determined, so that the time information of the sub-data tasks can be adjusted in a coordinated manner to ensure that the target data task can be completed on time. In addition, because different timing relationships between the task completion time and the service level agreement time of the sub-data task may be displayed in the Gantt chart through different display styles, the execution status of each sub-data task may be quickly determined according to the timing relationship between the task completion time and the service level agreement time, and an abnormal problem in the execution process of the sub-data task is found in time.

In a possible implementation, the first display module 1202 may include:
a first display unit configured to, for each sub-data task included in the target task link, display an average execution time period of the sub-data task in a first rectangular box, an actual execution time period of the sub-data task in a second rectangular box, and service level agreement time of the sub-data task in a graphic marker, wherein the first rectangular box and the second rectangular box are displayed in different display styles.

In a possible implementation, the first display module 1202 may include:
a second display unit configured to, for each sub-data task included in the target task link, when the task completion time of the sub-data task is earlier than the service level agreement time of the sub-data task, display a timing relationship between the task completion time of the sub-data task and the service level agreement time of the sub-data task in a rectangular box with a first style; and
a third display unit configured to when the task completion time of the sub-data task is later than the service level agreement time of the sub-data task, display a timing relationship between the task completion time of the sub-data task and the service level agreement time of the sub-data task in a rectangular box with a second style, wherein the first style is different from the second style.

In a possible implementation, the second display unit may be configured to display, in a first display color, a rectangular box representing the actual execution time period of the sub-data task, and/or display the rectangular box representing the actual execution time period of the sub-data task and a graphic marker representing the service level agreement time of the sub-data task in an overlapping manner; and
the third display unit may be configured to display, in a second display color, a rectangular box representing the actual execution time period of the sub-data task, and/or display the rectangular box representing the actual execution time period of the sub-data task and a graphic marker representing the service level agreement time of the sub-data task in a non-overlapping manner.

In a possible implementation, the Gantt chart displays execution time information of the sub-data task in the form of a rectangular box. Correspondingly, the apparatus 1200 may further include:
a second display module configured to, in response to a hover operation or a selection operation for a target rectangular box in the Gantt chart, display task time information of a sub-data task corresponding to the target rectangular box, wherein the task time information includes at least one selected from the group consisting of average completion time, actual completion time, and service level agreement time of the sub-data task; and/or
a third display module configured to, when task identification information of a sub-data task corresponding to the rectangular box is displayed, displaying task attribute information of the sub-data task corresponding to the task identification information in response to a hover operation or a selection operation for the task identification information, wherein the task attribute information includes a signature status of the service level agreement time of the sub-data task and/or business team information to which the sub-data task belongs.

In a possible implementation, the Gantt chart displays execution time information of the sub-data task in the form of a rectangular box, and the Gantt chart displays the service level agreement time of the sub-data task in a first graphic marker. Correspondingly, the apparatus 1200 may further include:
a fourth display module configured to display the first graphic markers corresponding to the sub-data tasks with different signature statuses in different colors, wherein the signature statuses are signature statuses of the service level agreement time of the sub-data tasks; and/or
a fifth display module configured to display the signature statuses around the task identification information in second graphic markers when the task identification information corresponding to the task corresponding to the rectangular box is displayed, wherein different signature statuses are displayed in different styles of the second graphic markers, and the first graphic markers are different from the second graphic markers.

In a possible implementation, the apparatus 1200 may further include:
a sixth display module configured to determine, in response to a configuration operation for a display mode of the target data task, a display mode corresponding to the configuration operation, and display a Gantt chart interface when the display mode indicates to display the target data task in the form of a Gantt chart;

Accordingly, the first determination module 1201 may include:
a sub-module configured to determine, in response to a selection operation for a task link corresponding to a target data task in the Gantt chart interface, a sub-data task in a target task link corresponding to the selection operation.

In a possible implementation, the apparatus 1200 may further include:
a second determining module configured to determine, in response to a switching operation for a display mode of the target data task, a first display mode corresponding to the switching operation; and
a switching module configured to switch from the Gantt chart interface to a first management interface corresponding to the first display mode,
wherein the first display mode includes a list mode and/or a directed acyclic graph mode, the list mode is used to display task information of all sub-data tasks under the target data task in the form of a list, and the directed acyclic graph mode is at least used to display an execution dependency relationship between the sub-data tasks under the target data task in the form of a directed acyclic graph.

In a possible implementation, the apparatus 1200 may further include:
an updating module configured to determine, in response to a task screening operation, a screening condition corresponding to the task screening operation, and update the task time information displayed in the Gantt chart according to the screening condition, so that the Gantt chart displays task time information of the sub-data tasks that meet the screening condition.

Based on the same concept, the embodiments of the present disclosure further provide a computer-readable medium having a computer program stored thereon, where when the program is executed by a processing apparatus, the steps of the method according to any one of the first aspect are implemented.

Based on the same concept, the embodiments of the present disclosure further provide an electronic device, including:
a storage apparatus having a computer program stored thereon; and
a processing apparatus configured to execute the computer program in the storage apparatus to implement the steps of the method according to any one of the first aspect.

Reference is made to FIG. 13 below, which shows a schematic structural diagram of an electronic device 1300 suitable for implementing the embodiments of the present disclosure. The terminal device in the embodiments of the present disclosure may include, but is not limited to, mobile terminals such as mobile phones, notebook computers, digital broadcast receivers, PDAs (personal digital assistants), PADs (tablet computers), PMPs (portable multimedia players), and vehicle-mounted terminals (such as vehicle navigation terminals), and fixed terminals such as digital TVs and desktop computers. The electronic device 1300 shown in FIG. 13 is merely an example, and should not impose any limitation on the function and scope of use of the embodiments of the present disclosure.

As shown in FIG. 13, the electronic device 1300 may include a processing apparatus (e.g., a central processor, a graphics processor, etc.) 1301 that may perform various appropriate actions and processing in accordance with a program stored in a read-only memory (ROM) 1302 or a program loaded from a storage apparatus 1308 into a random access memory (RAM) 1303. The RAM 1303 also stores various programs and data required for the operation of the electronic device 1300. The processing apparatus 1301, the ROM 1302, and the RAM 1303 are connected to each other through a bus 1304. An input/output (I/O) interface 1305 is also connected to the bus 1304.

Generally, the following apparatuses may be connected to the I/O interface 1305: an input apparatus 1306 including, for example, a touch screen, a touchpad, a keyboard, a mouse, a camera, a microphone, an accelerometer, and a gyroscope; an output apparatus 1307 including, for example, a liquid crystal display (LCD), a speaker, and a vibrator; the storage apparatus 1308 including, for example, a tape and a hard disk; and a communication apparatus 1309. The communication apparatus 1309 may allow the electronic device 1300 to perform wireless or wired communication with other devices to exchange data. Although FIG. 13 shows the electronic device 1300 having various apparatuses, it should be understood that it is not required to implement or have all of the shown apparatuses. It may be an alternative to implement or have more or fewer apparatuses.

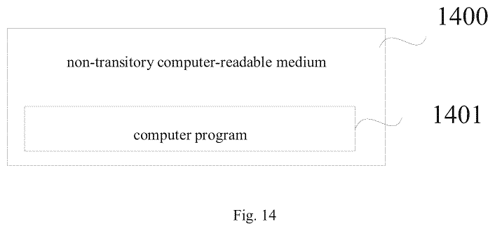

FIG. 14 is a schematic diagram of a structure of a non-transitory computer-readable medium according to an exemplary embodiment of the present disclosure. Referring to FIG. 14, the non-transitory computer-readable medium 1400 has a computer program 1401 stored thereon, when the computer program 1401 is executed by a processing apparatus, causes the processing apparatus to implement the method described above.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 1309, or installed from the storage apparatus 1308, or installed from the ROM 1302. When the computer program is executed by the processing apparatus 1301, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to electric wires, optical cables, radio frequency (RF), etc., or any suitable combination thereof.

In some implementations, communication may be performed using any currently known or future-developed network protocol such as HTTP (HyperText Transfer Protocol), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, and is not assembled into the electronic device.

The above computer-readable medium carries one or more programs that, when executed by the electronic device, cause the electronic device to: determine, in response to a selection operation for a task link corresponding to a target data task, a sub-data task in a target task link corresponding to the selection operation; and display task time information of the sub-data task in the target task link in the form of a Gantt chart according to a hierarchical relationship of the sub-data task in the target task link, wherein different timing relationships between a task completion time and a service level agreement time of the sub-data task are displayed in the Gantt chart through different display styles.

The computer program code for performing the operations in the present disclosure may be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate possible system architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by software, or may be implemented by hardware. The name of the module does not constitute a limitation on the module in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

The above description is only a preferred embodiment of the present disclosure and an illustration of the applied technical principles. Persons skilled in the art should understand that the scope of disclosure involved in the present disclosure is not limited to the technical solution formed by the specific combination of the above technical features, and should also cover other technical solutions formed by any combination of the above technical features or their equivalent features without departing from the above disclosure concept. For example, a technical solution formed by replacing the above features with technical features with similar functions disclosed in the present disclosure (but not limited thereto).

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the above discussions, these details should not be construed as limiting the scope of the present disclosure. Some features that are described in the context of separate embodiments may also be implemented in combination in a single embodiment. In contrast, various features described in the context of a single embodiment may also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims. Regarding the apparatus in the above embodiments, the specific manner in which each module performs an operation has been described in detail in the embodiments related to the method, and will not be described in detail here.

1. A data task management method, comprising:
determining, in response to a selection operation for a task link corresponding to a target data task, at least one sub-data task comprised in a target task link corresponding to the selection operation; and
displaying task time information of the at least one sub-data task comprised in the target task link in a form of a Gantt chart, according to a hierarchical relationship of the at least one sub-data task, wherein different timing relationships between task completion time of the at least one sub-data task and service level agreement time of the at least one sub-data task are displayed in the Gantt chart through different display styles.

2. The method according to claim 1, wherein the displaying task time information of the at least one sub-data task comprised in the target task link in a form of a Gantt chart, comprises:
for each sub-data task comprised in the target task link, displaying an average execution time period of the sub-data task in a first rectangular box, an actual execution time period of the sub-data task in a second rectangular box, and service level agreement time of the sub-data task in a graphic marker, wherein the first rectangular box and the second rectangular box are displayed in different display styles.

3. The method according to claim 1, wherein the displaying task time information of the at least one sub-data task comprised in the target task link in a form of a Gantt chart, comprises:
for each sub-data task comprised in the target task link, when the task completion time of the sub-data task is earlier than the service level agreement time of the sub-data task, displaying a timing relationship between the task completion time of the sub-data task and the service level agreement time of the sub-data task in a rectangular box with a first style;
when the task completion time of the sub-data task is later than the service level agreement time of the sub-data task, displaying a timing relationship between the task completion time of the sub-data task and the service level agreement time of the sub-data task in a rectangular box with a second style, wherein the first style is different from the second style.

4. The method according to claim 3, wherein the displaying a timing relationship between the task completion time of the sub-data task and the service level agreement time of the sub-data task in a rectangular box with a first style, comprises:
displaying, in a first display color, a rectangular box representing an actual execution time period of the sub-data task, and/or displaying the rectangular box representing the actual execution time period of the sub-data task and a graphic marker representing the service level agreement time of the sub-data task in a non-overlapping manner; and
the displaying a timing relationship between the task completion time of the sub-data task and the service level agreement time of the sub-data task in a rectangular box with a second style, comprises:
displaying, in a second display color, a rectangular box representing the actual execution time period of the sub-data task, and/or displaying the rectangular box representing the actual execution time period of the sub-data task and the graphic marker representing the service level agreement time of the sub-data task in an overlapping manner.

5. The method according to claim 1, wherein the Gantt chart displays execution time information of the at least one sub-data task in the form of a rectangular box, and the method further comprises:
in response to a hover operation or a selection operation for a target rectangular box in the Gantt chart, displaying task time information of a sub-data task corresponding to the target rectangular box, wherein the task time information comprises at least one selected from the group consisting of average completion time, actual completion time, and service level agreement time of the sub-data task; and/or
when task identification information of a sub-data task is displayed, displaying task attribute information of the sub-data task corresponding to the task identification information in response to a hover operation or a selection operation for the task identification information, wherein the task attribute information comprises a signature status of the service level agreement time of the sub-data task and/or business team information to which the sub-data task belongs.

6. The method according to claim 1, wherein the Gantt chart displays execution time information of the at least one sub-data task in a form of a rectangular box, and the Gantt chart displays the service level agreement time of the at least one sub-data task in a first graphic marker, and
the method further comprises:
displaying first graphic markers corresponding to sub-data tasks with different signature statuses in different colors, wherein the signature statuses are signature statuses of the service level agreement time of the sub-data tasks; and/or
when task identification information of a sub-data task is displayed, displaying a signature status around the task identification information through a second graphic marker, wherein different signature statuses are displayed in different styles of second graphic markers, and the first graphic marker is different from the second graphic marker.

7. The method according to claim 1, further comprising:
determining, in response to a configuration operation for a display mode of the target data task, a display mode corresponding to the configuration operation, and displaying a Gantt chart interface when the display mode indicates to display the target data task in the form of a Gantt chart;
the determining, in response to a selection operation for a task link corresponding to a target data task, at least one sub-data task comprised in a target task link corresponding to the selection operation, comprises:
determining, in response to the selection operation for the task link corresponding to the target data task in the Gantt chart interface, the at least one sub-data task comprised in the target task link corresponding to the selection operation.

8. The method according to claim 7, further comprising:
determining, in response to a switching operation for a display mode of the target data task, first display mode corresponding to the switching operation; and
switching from the Gantt chart interface to first management interface corresponding to the first display mode,
wherein the first display mode comprises a list mode and/or a directed acyclic graph mode, the list mode is used to display task information of all sub-data tasks under the target data task in the form of a list, and the directed acyclic graph mode is at least used to display an execution dependency relationship between respective sub-data task in the target data task in a form of a directed acyclic graph.

9. The method according to claim 1, further comprising:
determining, in response to a task screening operation, a screening condition corresponding to the task screening operation, and updating the task time information displayed in the Gantt chart according to the screening condition, so as to make the Gantt chart display task time information of one or more sub-data tasks that meet the screening condition.

10. A data task management apparatus, comprising:
a first determination module, configured to determine, in response to a selection operation for a task link corresponding to a target data task, at least one sub-data task comprised in a target task link corresponding to the selection operation; and
a first display module, configured to display task time information of the at least one sub-data task comprised in the target task link in a form of a Gantt chart, according to a hierarchical relationship of the at least one sub-data task, wherein different timing relationships between task completion time of the at least one sub-data task and service level agreement time of the at least one sub-data task are displayed in the Gantt chart through different display styles.

11. A non-transitory computer-readable medium having a computer program stored thereon, wherein when the computer program is executed by a processing apparatus, cause the processing apparatus to implement the method according to claim 1.

12. An electronic device, comprising:
a storage apparatus having a computer program stored thereon; and
a processing apparatus configured to execute the computer program in the storage apparatus to implement a data task management method,
wherein the data task management method comprises:
determining, in response to a selection operation for a task link corresponding to a target data task, at least one sub-data task comprised in a target task link corresponding to the selection operation; and
displaying task time information of the at least one sub-data task comprised in the target task link in a form of a Gantt chart, according to a hierarchical relationship of the at least one sub-data task, wherein different timing relationships between task completion time of the at least one sub-data task and service level agreement time of the at least one sub-data task are displayed in the Gantt chart through different display styles.

13. The electronic device according to claim 12, wherein the displaying task time information of the at least one sub-data task comprised in the target task link in a form of a Gantt chart, comprises:
for each sub-data task comprised in the target task link, displaying an average execution time period of the sub-data task in a first rectangular box, an actual execution time period of the sub-data task in a second rectangular box, and service level agreement time of the sub-data task in a graphic marker, wherein the first rectangular box and the second rectangular box are displayed in different display styles.

14. The electronic device according to claim 12, wherein the displaying task time information of the at least one sub-data task comprised in the target task link in a form of a Gantt chart, comprises:
for each sub-data task comprised in the target task link, when the task completion time of the sub-data task is earlier than the service level agreement time of the sub-data task, displaying a timing relationship between the task completion time of the sub-data task and the service level agreement time of the sub-data task in a rectangular box with a first style;
when the task completion time of the sub-data task is later than the service level agreement time of the sub-data task, displaying a timing relationship between the task completion time of the sub-data task and the service level agreement time of the sub-data task in a rectangular box with a second style, wherein the first style is different from the second style.

15. The electronic device according to claim 12, wherein the displaying a timing relationship between the task completion time of the sub-data task and the service level agreement time of the sub-data task in a rectangular box with a first style, comprises:
displaying, in a first display color, a rectangular box representing an actual execution time period of the sub-data task, and/or displaying the rectangular box representing the actual execution time period of the sub-data task and a graphic marker representing the service level agreement time of the sub-data task in a non-overlapping manner; and
the displaying a timing relationship between the task completion time of the sub-data task and the service level agreement time of the sub-data task in a rectangular box with a second style, comprises:
displaying, in a second display color, a rectangular box representing the actual execution time period of the sub-data task, and/or displaying the rectangular box representing the actual execution time period of the sub-data task and the graphic marker representing the service level agreement time of the sub-data task in an overlapping manner.

16. The electronic device according to claim 12, wherein the Gantt chart displays execution time information of the at least one sub-data task in the form of a rectangular box, and the method further comprises:
in response to a hover operation or a selection operation for a target rectangular box in the Gantt chart, displaying task time information of a sub-data task corresponding to the target rectangular box, wherein the task time information comprises at least one selected from the group consisting of average completion time, actual completion time, and service level agreement time of the sub-data task; and/or
when task identification information of a sub-data task is displayed, displaying task attribute information of the sub-data task corresponding to the task identification information in response to a hover operation or a selection operation for the task identification information, wherein the task attribute information comprises a signature status of the service level agreement time of the sub-data task and/or business team information to which the sub-data task belongs.

17. The electronic device according to claim 12, wherein the Gantt chart displays execution time information of the at least one sub-data task in a form of a rectangular box, and the Gantt chart displays the service level agreement time of the at least one sub-data task in a first graphic marker, and
the method further comprises:
displaying first graphic markers corresponding to sub-data tasks with different signature statuses in different colors, wherein the signature statuses are signature statuses of the service level agreement time of the sub-data tasks; and/or
when task identification information of a sub-data task is displayed, displaying a signature status around the task identification information through a second graphic marker, wherein different signature statuses are displayed in different styles of second graphic markers, and the first graphic marker is different from the second graphic marker.

18. The electronic device according to claim 12, further configured to:
determine, in response to a configuration operation for a display mode of the target data task, a display mode corresponding to the configuration operation, and display a Gantt chart interface when the display mode indicates to display the target data task in the form of a Gantt chart;
the determining, in response to a selection operation for a task link corresponding to a target data task, at least one sub-data task comprised in a target task link corresponding to the selection operation, comprises:
determining, in response to the selection operation for the task link corresponding to the target data task in the Gantt chart interface, the at least one sub-data task comprised in the target task link corresponding to the selection operation.

19. The electronic device according to claim 18, further configured to:
determine, in response to a switching operation for a display mode of the target data task, first display mode corresponding to the switching operation; and
switch from the Gantt chart interface to first management interface corresponding to the first display mode,
wherein the first display mode comprises a list mode and/or a directed acyclic graph mode, the list mode is used to display task information of all sub-data tasks under the target data task in the form of a list, and the directed acyclic graph mode is at least used to display an execution dependency relationship between respective sub-data task in the target data task in a form of a directed acyclic graph.

20. The electronic device according to claim 12, further configured to:
determine, in response to a task screening operation, a screening condition corresponding to the task screening operation, and update the task time information displayed in the Gantt chart according to the screening condition, so as to make the Gantt chart display task time information of one or more sub-data tasks that meet the screening condition.
